(19) United States
(12) Patent Application Publication
(10) Pub. No.: US 2017/0323017 A1
(43) Pub. Date: Nov. 9, 2017

(54) Smart User Ratings System for User-relevant Filtered Ratings

(71) Applicants: Muhammad Mashhood Alam, Dublin, CA (US); Wasi Muhammad Alam, Dublin, CA (US)

(72) Inventors: Muhammad Mashhood Alam, Dublin, CA (US); Wasi Muhammad Alam, Dublin, CA (US)

(21) Appl. No.: 15/149,105

(22) Filed: May 7, 2016

(51) Int. Cl. G06F 17/30; G06F 3/0484; G06F 1/16; H04L 29/08

(52) U.S. Cl. CPC G06F 17/30867; H04L 67/306; G06F 17/3053; G06F 1/163; G06F 3/04842; G06F 3/04847

(57) ABSTRACT

Smart User Ratings invention is a method and system of providing filtered ratings of user-generated ratings of objects available on online outlets based on relevance to user's personal profile parameters. Users of the invention can have a more personalized understanding of likability for objects available on online outlets.

### RELATED APPLICATION

This application claims priority of U.S. Provisional Patent Application Ser. No. 62/239,971 of the present inventors filed on Oct. 10, 2015, entitled Smart User Ratings System For User-relevant Filtered Ratings, incorporated herein for reference.

### FIELD OF THE INVENTION

The present invention relates to the field of objects in an online outlet accessed by users using client computer.

### BACKGROUND

Currently, most of the online websites (for example, www.amazon.com) and app stores (for example, iTunes and Google Play) provide a summarized rating based on user feedback on a 5-star scale for the objects displayed online (websites, mobile devices and other electronic medium). This rating is derived by the way of computational logic, most commonly weighted average of all the ratings provided by other users. Some online outlets incorporate more sophisticated algorithms including machine learning to calculate the summarized ratings for the displayed objects. They also display number of users with specific ratings (from 1 to 5 stars). However, none of these online outlets provides a mechanism to filter these ratings based on profile parameters relevant for users.

### BRIEF DESCRIPTION OF DRAWINGS

Following descriptions explain the focus of each of the attached figures included in this patent application.

FIG. 1 is an example graphical user interface (GUI) of how the current ratings (ratings score) are being displayed in an online environment (Prior art).

FIG. 2 is an example graphical user interface (GUI) of how the current detailed ratings (ratings score and ratings table) are being displayed in an online environment (Prior art).

FIG. 3 is an example graphical user interface (GUI) of how this invention of Smart User ratings (ratings score) will be displayed in an online environment.

FIG. 4 is an example graphical user interface (GUI) of how this invention of Smart User detailed ratings (ratings score and ratings table) will be displayed in an online environment.

FIG. 5 is an example graphical user interface (GUI) of how this invention of Smart User detailed ratings will be displayed along with the filter parameters in an online environment.

FIG. 6 is an example graphical user interface (GUI) of how this invention of Smart User detailed ratings will be displayed along with the filter parameters and ability of the user to change those filter parameters in an online environment.

FIG. 7 is the block diagram of how this invention will be used by a calling application or website.

FIG. 8 is the flow chart explaining how this invention will be used.

FIG. 9 is the functional block diagram of this system and its interaction with calling applications/websites and with end-users.

FIG. 10 is a diagram explaining one way this invention will interact with calling application/websites and users in which communication with the calling applications as well as the user will happen over a network. Communication with the user may also happen via the calling application/website.

FIG. 11 is a diagram explaining second way this invention will interact with calling application/websites and users in which Smart User Ratings system will be installed on a separate server inside the calling application environment. Communication with the end user may happen directly over network or via the calling application server.

FIG. 12 is a diagram explaining another way this invention will interact with calling application/websites and users in which Smart User Ratings system will be installed on the same server as the calling application environment. Communication with the end user may happen directly over network or via the calling application.

FIG. 13 is a flow chart of user interaction with calling application with Smart User Ratings system.

FIG. 14 is a screenshot of the main screen in the calling application where Smart User Ratings system is enabled.

FIG. 15 is a screenshot of the Smart User Ratings system where user clicks to see Filter Screen with filter parameters and selected filter parameter values.

FIG. 16 is a screenshot of the Smart User Ratings system where user clicks to change Filter parameter value to see updated ratings and ratings table.

FIG. 17 is a screenshot of the Smart User Ratings system where user clicks to deselect specific Filter parameter to see updated SURatings and SURatings table.

FIG. 18 is a screenshot of the Smart User Ratings system where user clicks to select additional Filter parameters and filter parameter values to see updated SURatings and SURatings table.

### DETAILED DESCRIPTION

### Summary

This invention is a method and system for providing filtered ratings of user-generated ratings of objects available at online outlets.

Currently, user generated ratings are generated by members (users) on a 5-point scale, where a higher number corresponds to a more favorable rating and the result is stored in a database. Other parameters that relate to the user (including age, gender, ethnicity, etc.) of the users who provided those ratings are stored on the database or could be derived. Individual ratings are consolidated to compute the overall rating score of the object using computational logic (exemplified, but not limited to, the use of weighted average of individual user ratings). The rating score is usually displayed on the user interface using five stars filled with color (generally yellow) in accordance with the rating score of the object. Current systems also display number of users who rated the object on various points of the scale (1 through 5). In current approach, users who view those rating scores do not have any insights into the other users who actually provided the individual ratings, on which the consolidated ratings are based on. Users are not able to filter this rating score based on profile parameters that represent themselves.

This invention enables users to see ratings of relevance to them for an object at an online outlet. Relevance is determined using one or more parameters and parameter values specific to the user.
This invention makes available a list of parameters to be used for calculation of Smart User Ratings.
This invention allows online outlets to add parameters to the available list of parameters for calculation of Smart User Ratings.
This invention allows online outlets to select a subset of parameters to be used for calculation of Smart User Ratings and making it available for users.
This invention allows online outlets to select a subset of parameters to be used for calculation of Default Smart User Ratings (a.k.a. Like You Ratings).
This invention allows derivation of Smart User Ratings based on pre-determined parameters and parameter values of the user.
This invention allows users to select parameters and parameter values from the available list of parameters to derive Smart User Ratings.
This invention computes ratings score and ratings table as part of Smart User Ratings calculation.
This invention calculates Smart User Ratings using four different algorithms.
This invention allows a mechanism to add new algorithms to calculate Smart User Ratings.

### Definitions

Here is a list of all the definitions of terms used in this patent application.
Objects (110) Objects include, but are not limited to products, apps, websites, media, songs, videos, movies, books, courses, businesses, ratings platforms and other services available at online outlets.
Online (720) outlets Online outlets include, but are not limited to web sites, app stores and other electronic channels where an individual, entity or organization makes these objects available for viewing by users and allows its users to give ratings for these objects. It also includes rating platforms that provide rating collection and/or display of user ratings and feedbacks about objects offered on websites, app stores and other electronic channels.
User (990) A person who may be a member of an online outlet and is interested in finding user ratings for objects available online.
Ratings Ratings convey users' liking for specific object on a scale of, but not limited to 1 through 5. Ratings also indicates a combination of ratings score (310, 1430, 1450) and ratings table (420, 1520, 1720, 1820).
Ratings Score (310, 1430, 1450) A score between 1 and 5 with one-point decimal indicates the consolidated ratings of all the users who provided ratings on a 5-point scale. Individual user ratings are consolidated to compute the overall ratings of the object using computational logic (1010) (for example, weighted average of individual user ratings).
Ratings table (420, 1520, 1720, 1820) An array or table showing number of users for each point in the rating scale (1 through 5) (210).
5-point scale A scale for users to rate an object on. 1 being least liked; and 5 being most liked.
Parameters Any data that conveys information and attributes about users including, but not limited to age, age group, gender, ethnicity, education level, location, is a parent and others. Parameters are stored or derived user profile parameters and are also used for filtering ratings based on their values.
Smart User Ratings Ratings filtered based on filter parameters relevant to user.
SURatings A short form description for Smart User Ratings.
Rating Systems Any system that allows users to provide ratings on a scale of 1 to 5 and calculates a rating score of objects at online outlets.
Calling Application Any application that is used by users to viewing objects (720) online and read object ratings.
API (930) Application Programming Interface which is a mechanism for software programs such as Smart User Rating System to expose specific functionalities of the software to be used by external programs and applications.
Run-time In software applications, run-time refers to the duration when users in a production environment are using the software.
Network (910) Computer network that is used to connect computer systems and devices with each other. On a local level, it could be a LAN (Local Area Network), on a wider level, it could be a WAN (Wide Area Network) and on a global level it is the Internet.
Client Computer Client computer is any device that a user uses to access an (980) online outlet to review ratings of an object, including but not limited to desktop computers, laptop computers, virtual reality viewers, mobile devices including but not limited to cell phones, tablet computers, electronic watches and wearable devices.
Universal Parameter List List of parameters available for Online outlets to use for determining SURatings.
Online outlet specific Universal Parameter List List of parameters that is built with the addition of additional parameters that online outlets adds to the Universal Parameter List.

SURatings Parameter List List of Parameters that Online outlets selects from the universal parameter list or Online outlet specific Universal Parameter List.
Like You Parameter List A subset of SURatings Parameters List that is used to determined default SURatings (aka Like You Ratings).
Default SURatings Ratings that are derived based on the Like You Parameter List and values of the parameters based on the profile for the user.
Like You Ratings Another name for Default SURatings.
User-determined Ratings that are derived based on the SURatings
SURatings Parameter List and values of the parameters based on the profile for the user.
Algorithm #1 “SU Smart rating” Algorithm. This is the default algorithm.
Algorithm #2 “SU Weighted Average Rating based on number of entries” Algorithm.
Algorithm #3 “SU Weighted Average based on weights” Algorithm.
Algorithm #4 “SU simple rating” Algorithm.

### DESCRIPTION

This invention provides systems and methods for Smart User ratings using computer programs and storage based on filter parameters relevant to the user. These Smart User Ratings can be displayed on a graphical user Interface embedded within the GUI of the calling applications, websites or rating platforms. In the figures incorporated to illustrate features of an example embodiment, like reference numerals are used to identify like parts throughout the figures.

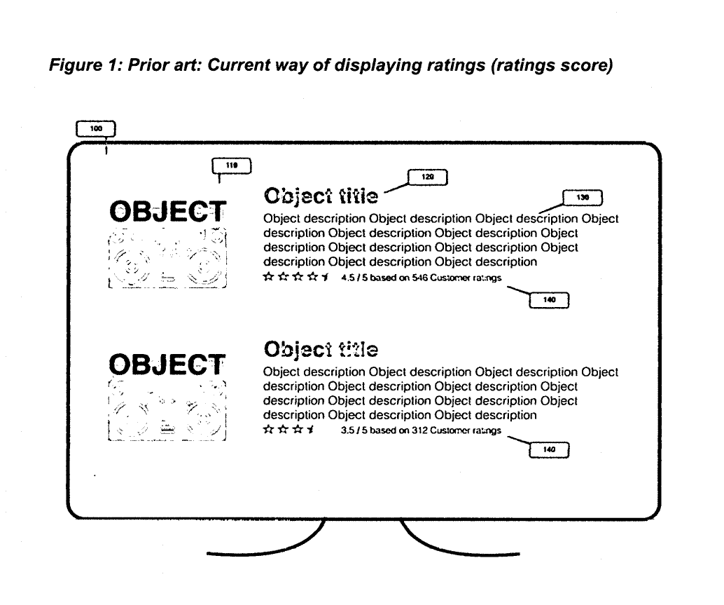

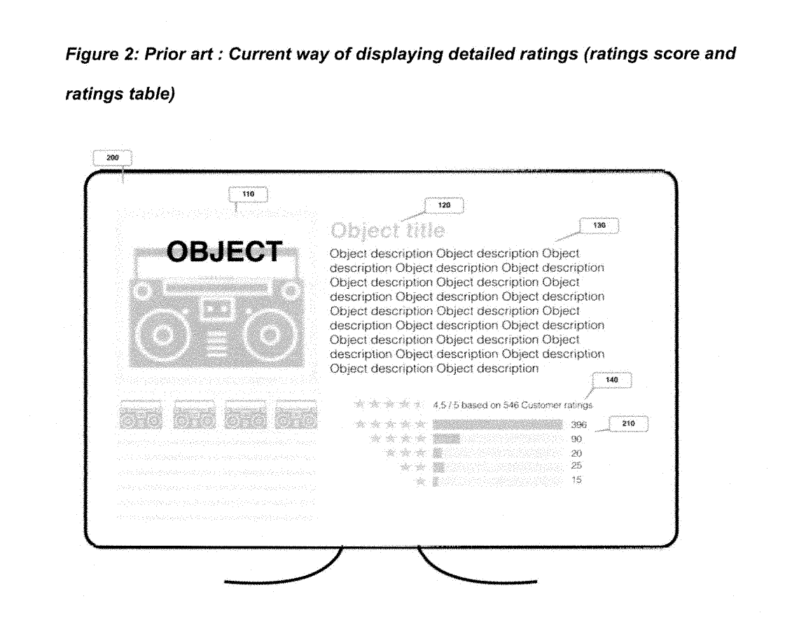

All online outlets enable their users to provide ratings for available objects on a scale 140, 1420. These ratings are summarized and made available for their users on their online outlets (FIG. 1). In addition, a more detailed breakdown of this ratings score is also displayed in the form of a ratings table 210 to the users as well (FIG. 2). There are different embodiments of these ratings. Most common embodiment is on a 5-point scale. Other embodiments include ratings on a 7-point scale, 10-point scale and other scales. This invention enables configuration of the system on a scale from 3 points to 100 points.

In the object ratings available at online outlets today, the user does not see is how many of those users are similar to themselves. This inability of the user to see ratings scores and rating tables ratings from other users like him/her, makes these ratings meaningless to the user.

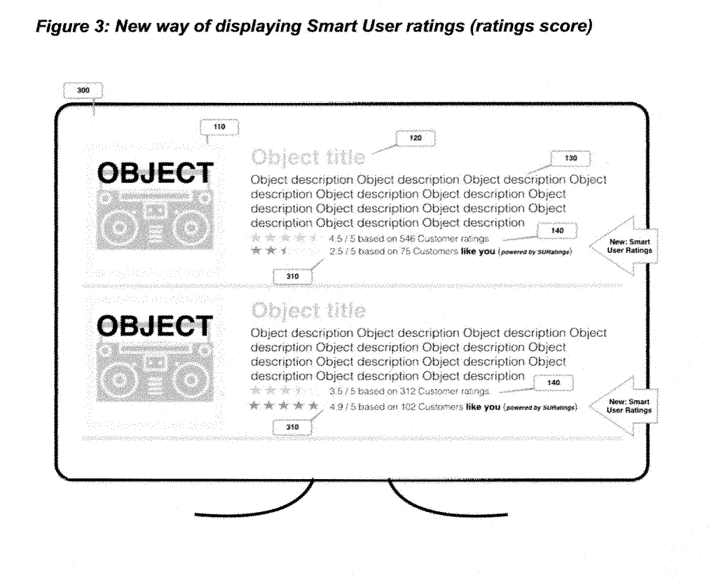

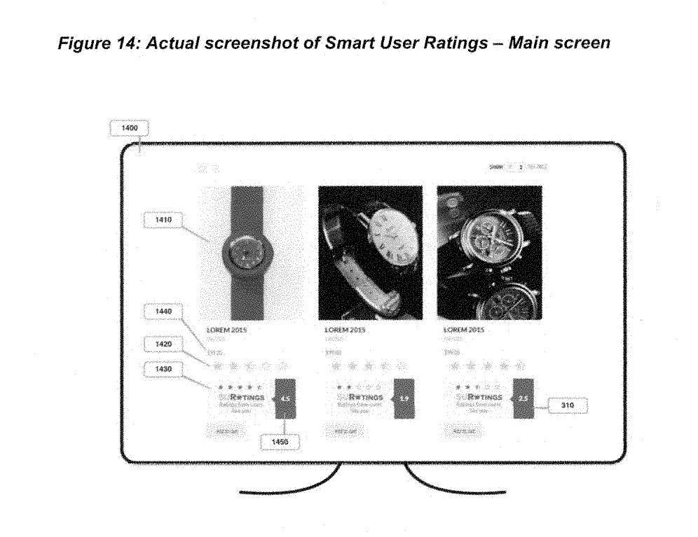

To solve this problem, Smart User Ratings systems enables users to view rating scores and rating tables from other users like them. It is termed as “Like You” ratings 310, 1430, 1450 or “default SURatings” (FIG. 3 and FIG. 14).

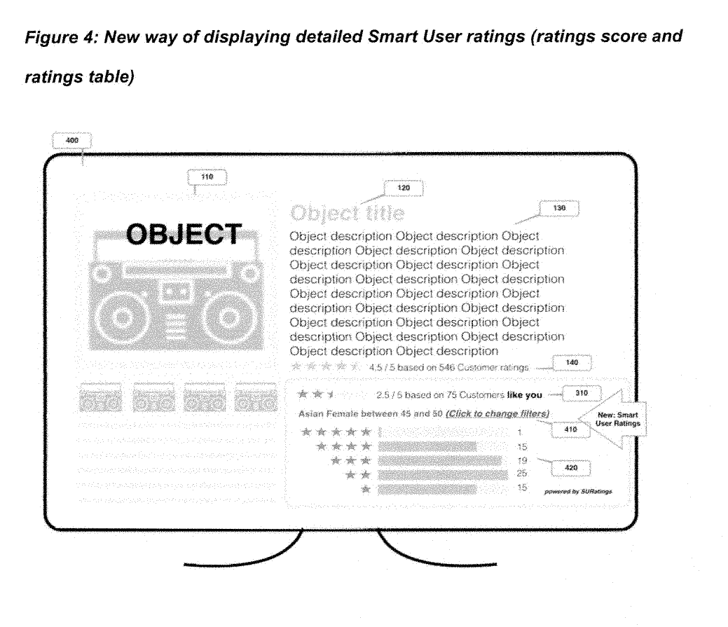

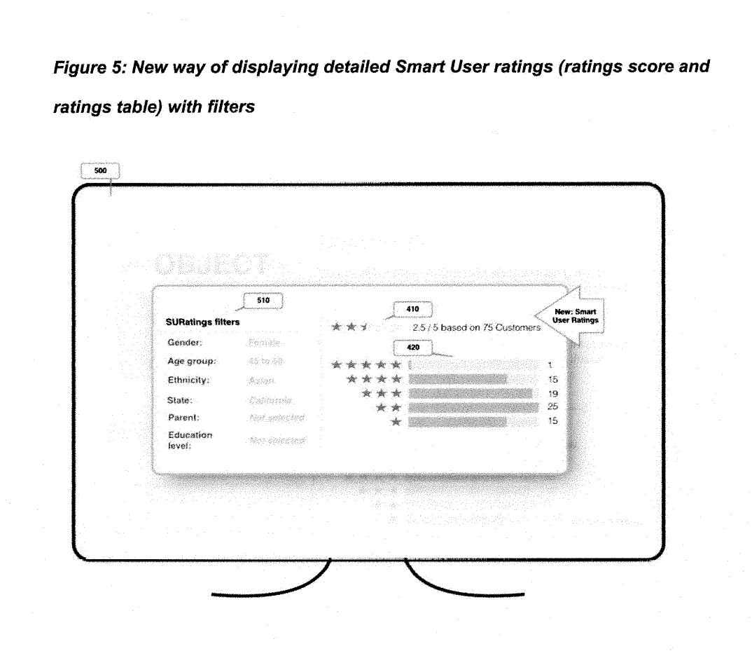

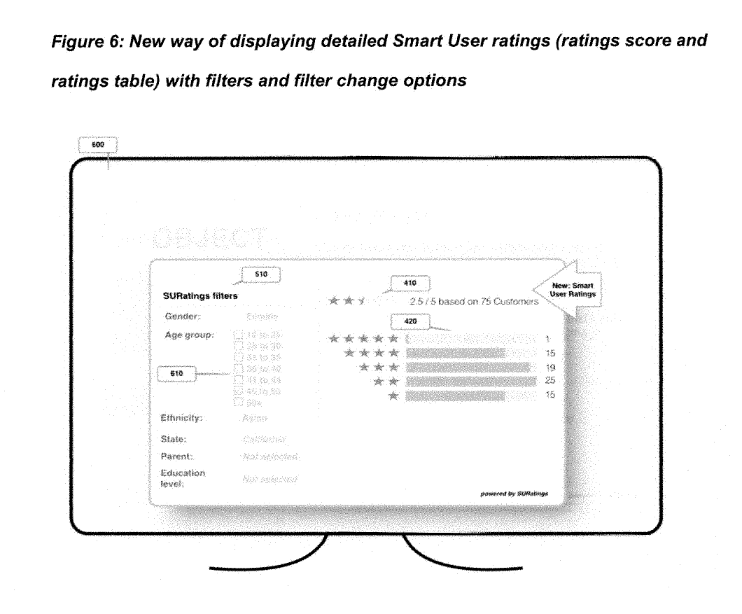

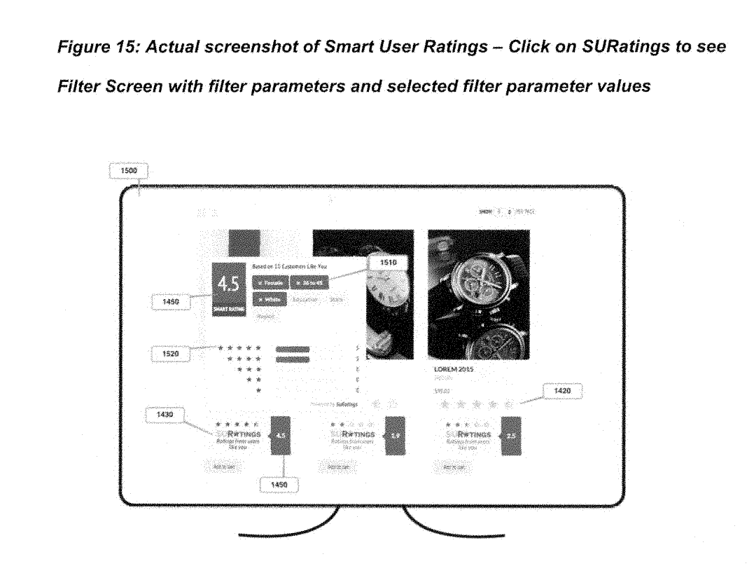

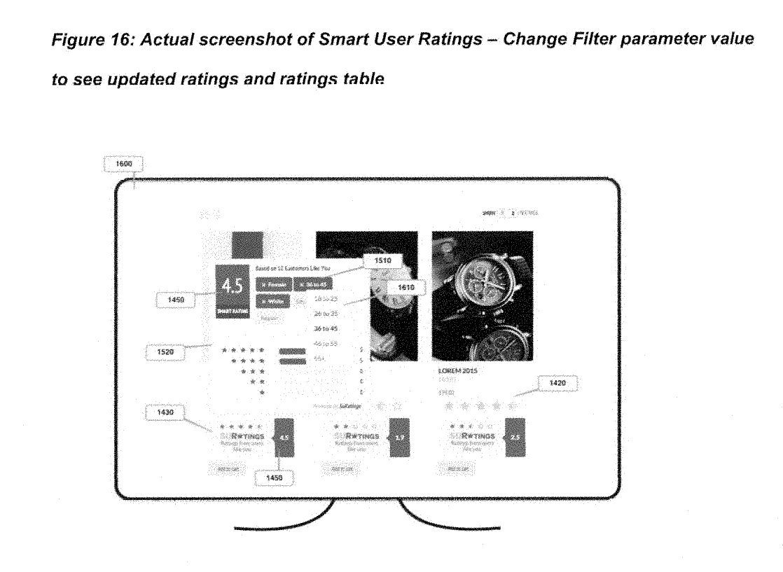

An example way that “Like You” ratings (including ratings score 310, 1430, 1450 (FIG. 3 and FIG. 14) and ratings table 420, 1520, 1720, 1820) is displayed in FIG. 4 and FIG. 15. This example also shows that the user interface also shows the summarized description on which parameters make up the “like You” filter criteria 410. User is able to click on a hyperlink to change these filters 410 for the purpose of changing the filter parameters and reviewing the ratings for different sets of parameters. FIG. 5 and FIG. 15 gives an example GUI that shows how the Smart User ratings filters 510, 1510, 1730, 1830 could be displayed to the user. User has the ability to click on each filter parameter value 610, 1610 to change the value and see updated filtered ratings as shown in FIG. 6 and FIG. 16.

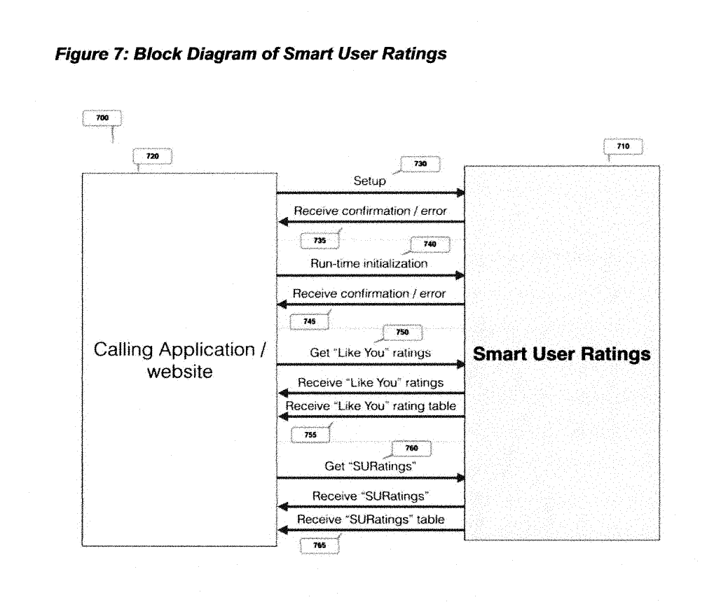

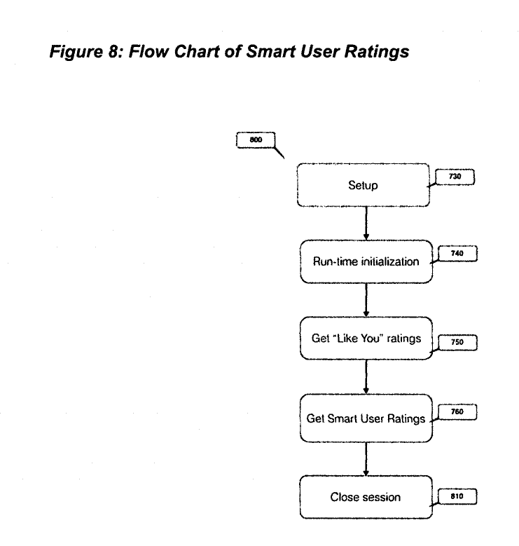

To enable this functionality for users, Smart User Ratings system need to be integrated with online outlets (a calling application/website 720) as shown in FIG. 7 and FIG. 8.

Smart User Ratings system makes available “Universal Parameter List” to the online outlets. The universal parameter list is a list of parameters that online outlets use to select the parameters they may select to calculate SURatings. Example of a small subset of parameters, as exemplified but not inclusive, is mentioned below:
Gender
Age group
Ethnicity
Education
State
Region
Religion

Online outlets are allowed to add parameters to Universal Parameter List to build “Online outlet specific Universal Parameter List”. See the example below where online outlet has added another parameter called “Item_size” to build the “Online outlet specific Universal Parameter List”.
Gender
Age group
Ethnicity
Education
State
Region
Religion
Item_Size

Online outlets select a subset of parameters from “Universal Parameter List” or “Online outlet specific Universal Parameter List” to build “SURatings Parameter List”. SURatings Parameter List is a set pf parameters that will be available for users to filter ratings around. For example shows 6 parameters that could be selected to build the SURatings Parameter List:
Gender
Age group
Ethnicity
Education
State
Region

Online outlets select a subset of parameters from “SURatings Parameter List” to build a “Like You Parameter List”. “Like You Parameter List” is a set of parameters that are used to calculate “Like You Ratings” or “Default SURatings” based on the parameter values representing the user. For example, following three parameters could be selected to determine “Default SURatings”:
Gender
Age group
Ethnicity

During run-time, as a user is reviewing objects on an online outlet, object reviews are filtered using “Like You Parameter List” allowing users to see Default SURatings (Like Your Ratings) for objects available on online outlets. For example, the default parameter values for the user are:
Gender=Male.
Age Group=35-45.
Ethnicity=Asian.

This invention allows users to view, select and deselect parameters from SURatings Parameters List. User is also allowed to select parameter values of their choice from the “SURatings Parameter List” and see SURatings based on the criteria user deems relevant. For example, a user may want to select the parameter value for age group to be between “18-25” although his default age group was set to be “35-45”.

This invention computes ratings score and ratings table as part of SURatings calculation. FIG. 6 gives a visual explanation of ratings score and ratings table.

This invention calculates Smart User Ratings using four different algorithms.

First algorithm in this invention is “SU Smart rating” which is the default algorithm. This algorithm calculates SURatings by taking the average of individual ratings by all users who have the same parameter values as the values selected by the user or the parameter values of the user in case of “Like You Ratings”.

Second algorithm in this invention is “SU Weighted Average Rating based on number of entries”. This algorithm calculates SURatings as follows: For each filter parameter, calculate the rating by adding the ratings of entries for each parameter and selected parameter value and dividing by number of users for that parameter value. Then take a weighted average of each of these ratings by multiplying average ratings of each parameter by their members, adding them together and dividing by total number of members (add number of members for each parameter).

Third algorithm in this invention is “SU Weighted Average based on weights”. This algorithm calculates SURatings as follows: For each filter parameter, calculate the rating by adding the ratings of entries for each parameter for the parameter value of the user or selected by the user and dividing by number of members for that parameter with same parameter value. Take a weighted average of each of these ratings by multiplying average ratings of each parameter by the weights configured by online outlet, adding them together and dividing by the sum of weights. This invention allows online outlets to configure weights for each of the parameters in the SURatings Parameter List.

Fourth algorithm in this invention is “SU simple rating”. This algorithm calculates SURatings as follows: For each filter parameter, calculate the rating by adding the ratings of entries for each parameter and dividing by number of members for that parameter. Take a simple average of relevant filter parameters without regard to how many members were in each filter parameter group or the weights. Add the ratings for each parameter and divide by number of parameters used to calculate SURatings.

This invention allows a mechanism to add new algorithms to calculate Smart User Ratings. Online outlet may need to calculate SURatings based on a logic that is different than the one provided by the four algorithms. Online outlets will be able to use this embodiment of the invention to accomplish the task.

Online outlet will call setup 730 API (Application Programming Interface). Smart User Ratings System will receive specific parameters to setup the system to be called by calling application during run-time. This setup process includes definition of “Online outlet specific Universal Parameter List”, “SURatings Parameter List”, “Like You Parameter List” and configuration of storage type to be used. Storage type could be calling application database 970 or transient storage of the Smart User rating system. Smart User Ratings System setup API will return 735 with a confirmation indicating to the calling application/website whether the setup was successful or not.

During run-time, the calling application will call run-time initialization API 740 to begin a new session for a user who is viewing ratings of an object. This API will also set the parameter values for the particular user. Depending on the storage type setup, either receive the array that includes other users' ratings and parameter values, or access this information from the database that was setup during the setup API 730 call.

To receive “Like You ratings” for the user, calling application will call “Get Like You ratings” API 750 and obtain the filtered rating score and the filtered rating table 755. This rating will then be displayed on the GUI where user is viewing the object FIG. 4 and FIG. 15.

As the user requests a changed filtered smart user ratings using the GUI FIG. 6 and FIG. 16, Get SURatings API 760 will be called by the calling application which sends the changed filter parameter values and receives “SURatings”—Smart User rating score and table 765.

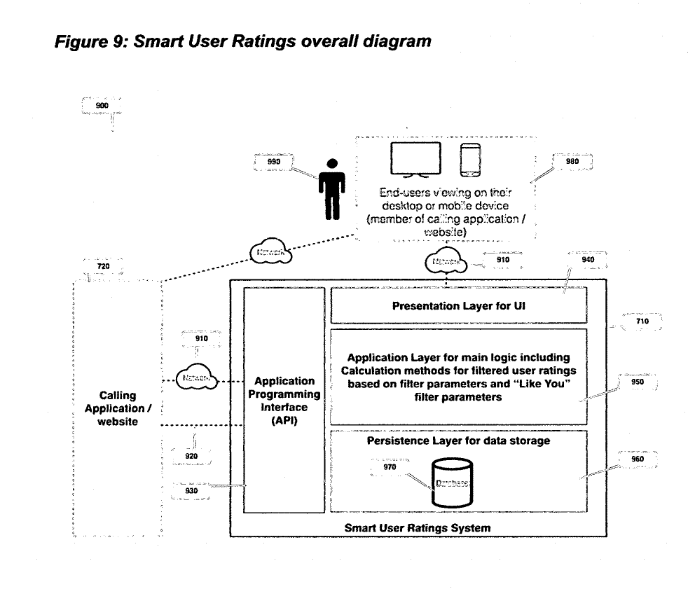

FIG. 9 gives an explanation of the key components of Smart User Ratings system 710 and how the user 990 and calling application uses Smart User Ratings Systems to enable users via a client computer 980 to have access to the filtered user ratings based on the parameters that matter to the user. The system comprises a core application layer 950 where the main computational logic resides. Application layer stores necessary information using the persistence layer 960 into a database 970. Application Programming Interface (API) 930 layer exposes the functionality to the calling applications. Calling applications 720 will have ability to call these APIs over a network 910 or directly 920 if installation is done in the same environment as the calling application. Smart User Rating system also has a presentation layer 940, to allow users 990 to see the Smart User Ratings on their devices 980 directly over a network 910.

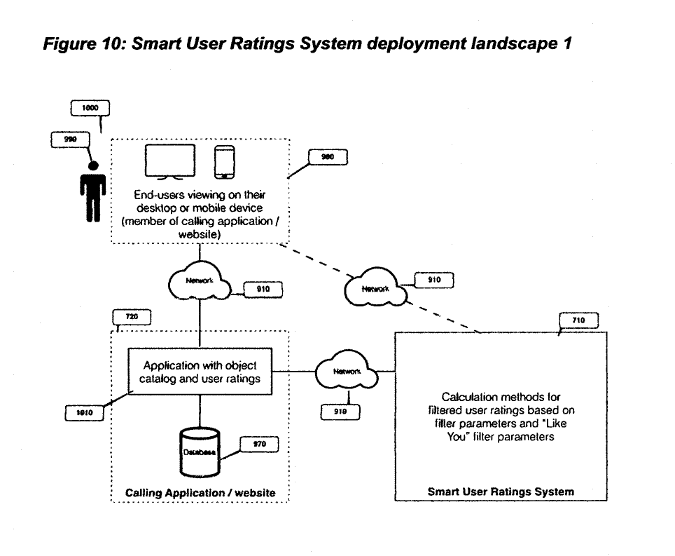

There are multiple ways in which Smart User Ratings system could be deployed. FIG. 10 is an example illustration of when Smart User Rating system is being deployed on its own landscape and is being accessed by calling application over a network 910. In this configuration, calling application's own logic and rating systems 1010 are stored on their own landscape. Users 990 are able to access the objects provided by calling application using their GUI over a network 910 on users' mobile device 980. User is able to see the Smart user ratings embedded in the GUI of calling application. These smart user ratings could either be rendered by the calling application on the user GUI, or it could be extracted directly from Smart User Ratings system over the network 910.

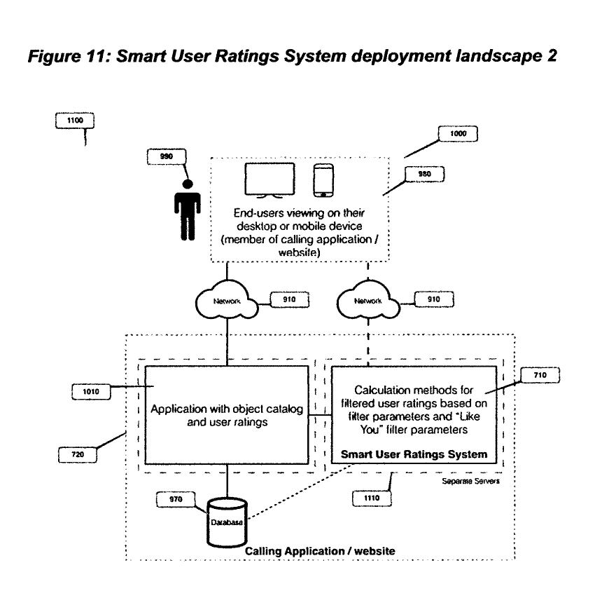

FIG. 11 is an example illustration of when Smart User Rating system is being deployed on the same landscape 720 as the calling application. In this configuration, Smart User rating system is installed in a separate server 1110 than the one calling application is deployed upon. Calling application accesses the Smart user ratings APIs directly. As in the previous configuration FIG. 10, calling application's own logic and rating systems 1010 are stored on their own landscape. Smart User ratings system may also access the user ratings from the calling application database 970 directly. Users 990 are able to access the objects provided by calling application using their GUI over a network 910 on users' mobile device 980. User is able to see the Smart user ratings embedded in the GUI of calling application. These smart user ratings could either be rendered by the calling application on the user GUI, or it could be extracted directly from Smart User Ratings system over the network 910.

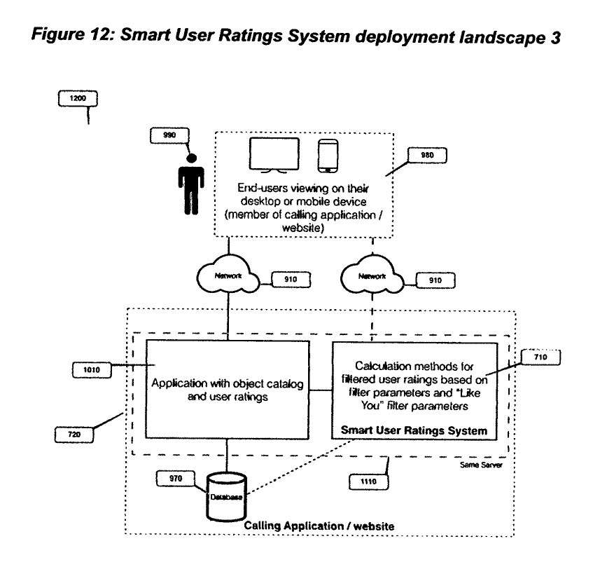

FIG. 12 is an example illustration of when Smart User Rating system is being deployed on the same landscape 720 as the calling application. In this configuration, Smart User rating system is installed on the same server 1110 as the one calling application is deployed upon. Calling application accesses the Smart user ratings APIs directly. As in the previous configuration FIG. 11, calling application's own logic and rating systems 1010 are stored on their own landscape. Smart User ratings system may also access the user ratings from the calling application database 970 directly. Users 990 are able to access the objects provided by calling application using their GUI over a network 910 on users' mobile device 980. User is able to see the Smart user ratings embedded in the GUI of calling application. These smart user ratings could either be rendered by the calling application on the user GUI, or it could be extracted directly from Smart User Ratings system over the network 910.

Profile parameters (510, 1510, 1730, 1830) include, but are not limited to age, age group, gender, ethnicity, education level, location, is a parent or any other information that conveys an aspect of user. In addition, this invention also allows users to see exact number of other users who have given specific ratings on the same filter criteria (420, 1520, 1720, 1820). Rating systems, calling applications or website (720) can use this invention to define set of parameters to be used for filtering (730), a list of filter parameters to define “Like You” filtering (730), get “Like You” ratings score and ratings table (750) and get Smart User ratings score and ratings table (760) as well as number of users and their specific ratings in a table (420, 1520, 1720, 1820) based on the filtered parameters (510, 1510, 1730, 1830). This invention will also enable these smart filtered ratings to be displayed on a graphical user interface (GUI) and allow calling applications, websites and rating systems to embed this GUI (310, 1430, 1450, 410, 420, 1520, 1720, 1820, 510, 1510, 1730, 1830, 610, 1610, 940) inside their own GUIs (FIG. 3 and FIG. 14).

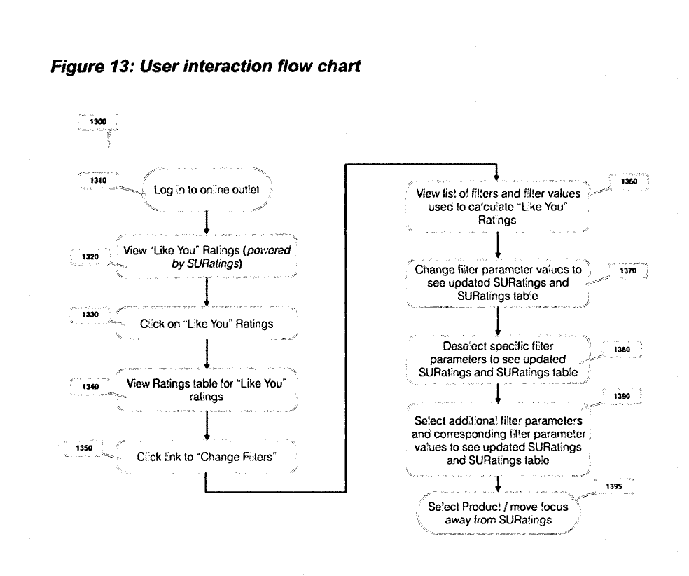

FIG. 13 is a flow chart that explains the user interaction with the online outlet and Smart User Ratings system. At run-time, user will log in to the online outlet 1310. Smart User Ratings will use profile parameters of the logged in user and calculate the SURatings for the user. User will be able to view the “Like You Ratings” 1320 with each object on the online outlet. User will click on the “Like You” Ratings 1330 and view the ratings table for “Like You” ratings 1340. User will also be able to view 1360 the parameters available for filtering and the values selected 1370 for each parameter. User will be able to change change these filters 1350. By deselecting specific filter parameters to see update SURatings score and table 1380. User will also be able to select additional filter parameters and corresponding filter parameter values to see updated SURatings 1390. User will be able to move focus away from SURatings 1395.

Snapshots from live implementation of the system can be seen in FIGS. 14, 15, 16, 17 and 18.

FIG. 14 shows an online outlet 1400, where some retail products are being sold. Pictures of objects 1410 helps users get a visual view of the object. Price also is shown 1440. Overall user ratings is also shown 1420. SURatings based on user profile parameters are also calculated and shown to the user to have a better idea of likeability of the object 1430, 1450.

As the user clicks on the SURatings display box, users sees the profile parameters and selected values 1510 to determine the SURatings as shown in FIG. 15. User is also able to see the SURatings table 1520.

User is able to select different values 1610 for filter each parameter used to calculate SURatings as shown in FIG. 16.

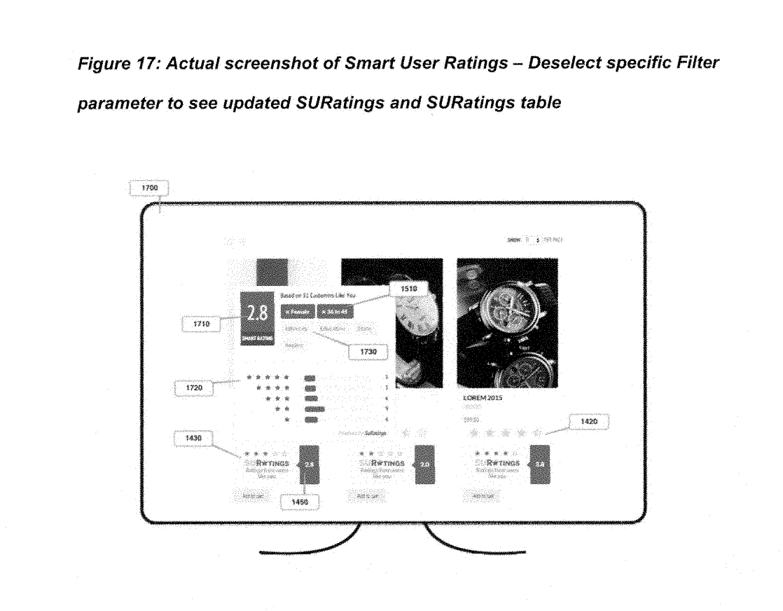

User is able to deselect any of the parameters 1730 to see update SURatings score 1710 and SURatings table 1720 as shown in the FIG. 17.

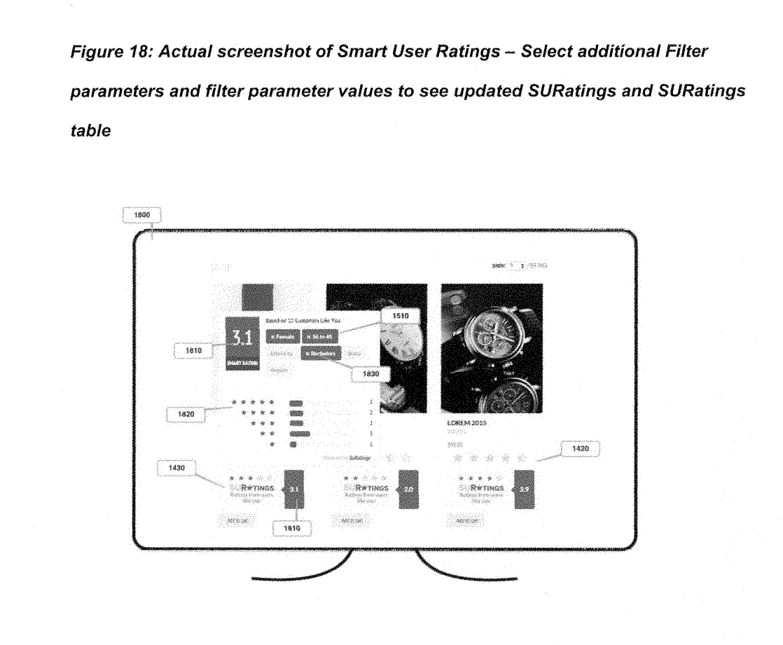

User is also able to select a different parameter and select available parameter value 1830, made available by the online outlet to see update SURatings score 1810 and SURatings table 1820 as shown in FIG. 18.

1. A method of deriving filtered ratings of an object available at online outlets, the method comprising:
a) a user interface for a user to view, define or modify filter ratings;
b) where the filter ratings are based on relevance to the user's personal profile parameters;
c) an algorithm to derive the filter ratings based on the personal profile parameters of the user;
d) the presentation of resultant ratings to the user on a client computer; and
e) a mechanism to integrate with online outlets.

2. A method of claim 1, integrated with online outlets on the same server, on a separate server or through API calls over a network.

3. A method of claim 1, wherein the filter ratings include ratings score and ratings table.

4. A method of claim 1, wherein the filter parameters and filter parameter values to be used for computing filter ratings are configured by the online outlet.

5. A method of claim 1, wherein the derivation algorithm calculates filter ratings.

6. A method of claim 1, wherein the client computer is a desktop computer, a laptop computer, a tablet computer, a mobile device, a wearable electronic device or a virtual reality viewer.

7. A method of claim 1, wherein the filter parameters are selected or deselected by one click or touch.

8. A method of claim 1, wherein the graphical user interface is embedded in the online outlet.

9. The graphical user interface of claim 8 allows the user to view, select and modify any filter parameters and associated filter parameter values.

10. A method of computing filter ratings based on the personal profile parameter values of the user where:
a) Personal parameters are defined by online outlet in persistent storage;
b) Personal parameters are configured to be used in derivation of filter ratings by online outlet in persistent storage;
c) Personal parameters are updated by user.

11. A method of computing filter ratings in claim 10, wherein computed filter ratings include ratings score and table.

12. A method of computing filter ratings in claim 10, wherein the ratings score is configured by the online outlet on a scale from 3 to 100.

13. A method of computing filter ratings in claim 10, wherein the existing object ratings are passed to the program or are retrieved from persistent storage during run-time.

14. A method of computing filter ratings in claim 10, wherein online outlet configures combination of parameters to be used to compute “Like You” ratings—ratings that are from other users similar to the current user.

15. A method of computing filter ratings in claim 10, wherein the computational logic includes an algorithm which calculates ratings by taking the average of individual ratings by all users who have the same parameter values as the values selected by the user or the parameter values of the user in case of “Like You Ratings”.

16. A method of computing filter ratings in claim 10, wherein the computational logic includes an algorithm which calculates ratings as follows: For each filter parameter, calculate the rating by adding the ratings of entries for each parameter and selected parameter value and dividing by number of users for that parameter value. Then take a weighted average of each of these ratings by multiplying average ratings of each parameter by their members, adding them together and dividing by total number of members (add number of members for each parameters).

17. A method of computing filter ratings in claim 10, wherein the computational logic includes an algorithm which calculates ratings as follows: For each filter parameter, calculate the rating by adding the ratings of entries for each parameter for the parameter value of the user or selected by the user and dividing by number of members for that parameter with same parameter value. Take a weighted average of each of these ratings by multiplying average ratings of each parameter by the weights configured by online outlet, adding them together and dividing by the sum of weights. This invention allows online outlets to configure weights for each of the parameters in the SURatings Parameter List.

18. A method of computing filter ratings in claim 10, wherein the computational logic includes an algorithm which calculates ratings as follows: For each filter parameter, calculate the rating by adding the ratings of entries for each parameter and dividing by number of members for that parameter. Take a simple average of relevant filter parameters without regard to how many members were in each filter parameter group or the weights. Add the ratings for each parameter and divide by number of parameters used to calculate SURatings.

19. A system comprising:
a computer program,
a program memory;
a storage device,
a graphical user interface, design to:
a) derive filtered ratings of an object available at online outlets,
b) derive filter ratings based on the personal profile parameters of the user,
c) derive filter ratings based on parameters and parameter values selected by user;
d) enable user to view, define or modify filter ratings on a client computer;
e) integrate with online outlets.

20. A system of claim 19, wherein the computer program is integrated with online outlets on the same server, on a separate server or through API calls over a network.

21. A system of claim 19, wherein the filter ratings include ratings score and ratings table.

22. A system of claim 19, wherein the filter parameters and filter parameter values to be used for computing filter ratings are configured by the online outlet.

23. A system of claim 19, wherein the client computer is a desktop computer, a laptop computer, a tablet computer, a mobile device, a wearable electronic device or a virtual reality viewer.

24. A system of claim 19, wherein the filter parameters are selected or deselected by one click or touch.

25. A system of claim 19, wherein the computer program calculates filter ratings score and table.

26. A system of claim 19, wherein the computer program allows new algorithm to be added to calculate filter ratings score and table.

27. A system of claim 19, wherein the ratings score is configured by the online outlet on a scale from 3 to 100.

28. A system of claim 19, wherein the existing object ratings information is passed to the program or are retrieved from persistent storage during run-time.

29. A system of claim 19, wherein online outlet configures combination of parameters to be used to compute “Like You” ratings—ratings that are from other users similar to the current user.

30. A system of claim 19, wherein the graphical user interface is embedded in the online outlet.

31. The graphical user interface of claim 30 allows the user to view, select and modify any filter parameter and associated filter parameter values.
